(19) United States
(12) Patent Application Publication
(10) Pub. No.: US 2017/0057700 A1
(43) Pub. Date: Mar. 2, 2017

(54) METHOD FOR FOLDING BAGS TO PROVIDE GREATER EASE IN OPENING AND IMPROVED PACKAGING

(71) Applicant: Patrick Ryan Breslend, Tallahassee, FL (US)

(72) Inventor: Patrick Ryan Breslend, Tallahassee, FL (US)

(21) Appl. No.: 14/815,986

(22) Filed: Aug. 24, 2015

(51) Int. Cl. B65D 30/20; B65D 33/00; B31B 29/74

(52) U.S. Cl. CPC B65D 31/10; B31B 29/74; B65D 33/001; B31B 2221/20

(57) ABSTRACT

A bag having a front side, a rear side, and left and right sides connecting the front and rear sides. When folded, the bag comprises a first simple gusset in at least one of the left and right sides and at least a second gusset in at least one of said left and right sides, wherein the second gusset is selected from the group consisting of a second simple gusset and a compound gusset formed from the first simple gusset. Preferably, the simple and compound gussets are formed in both left and right sides. The bag may comprise a plurality of simple gussets, compound gussets, and combinations thereof.

The present application draws priority from pending U.S. Provisional Patent Application, Ser. No. 61/999,732, filed Aug. 4, 2014; and also incorporates by reference in its entirety U.S. Pat. No. 8,387,815 B2, “Apparatus and method for sequential bagging of materials”, issued Mar. 5, 2013 to Patrick Breslend (the “815” patent).

### TECHNICAL FIELD

The present invention relates to bagging practice wherein a plurality of bags are used sequentially over time; more particularly, to a system for sequential bagging of materials wherein a plurality of bags to be used are stored in and dispensed from a bag-loading device that both supports each bag and distends the mouth of each bag for loading; and most particularly to an improved configuration of such a bag, with or without a bag-loading device, comprising bag sides having a plurality of pleated folds, also referred to herein as “simple gussets”. Such gussets may also be secondarily folded upon themselves to form compound gussets, as described hereinbelow. In this way, a bag may be folded to a width significantly less than the width of a bag-loading device such as a supportive structure, yet be easily openable without shaking.

### BACKGROUND OF THE INVENTION

It is well known to accumulate and transport materials in single-use plastic bags. This practice is used in activities ranging at least from residential and restaurant waste disposal, to industrial collection and shipping of in-transit letters and packages by delivery companies, to bagging of purchased items in department stores and supermarkets.

In the incorporated '815 patent, a multiple-bag pack is supported for dispensing, loading, and removal on a supportive structure (“container”) having an open top. The pack includes a bag-attachment portion wherein the multiple bags are sequentially attached in a fashion similar to the pages in a paper writing tablet. Each bag is removable in sequence by separation from the pack along a parting feature such as a line of perforations.

The bag pack is contained within the container, which may be circular, oval, or rectangular, and has first and second opposite lips. In this prior art embodiment, the bag-attachment portion is folded over the first lip to capture and secure the bag pack in the container by attachment on the outside of the container. The front edge of the outermost bag of the pack, defining the “front side” of the bag, is separated from the bag-attachment portion and is drawn across the open container top and over the second lip to open the bag for loading. The rear edge, defining the “rear side” of the bag, remains attached to the bag pack, fully distending the mouth of the bag. Left and right bag sides are formed between the front and rear sides, respectively. The left and right bag sides may be formed without vertical pleats or with a single pleat, also referred to herein as a “simple gusset”, in each of the left and right sides.

To change bags, the rear edge of the bag is separated from the pack and the first lip, presenting the front edge of the next bag in the pack. The front edge of the loaded bag is removed from the second lip, and the bag is closed and removed. The cycle is repeated until the bag pack is exhausted.

In both the prior art discussion below and the present invention, a bag and a corresponding container may be considered as having three orthogonal dimensional parameters defined herein as width (from side to side), length (from front side to back side), and depth (from top to bottom).

A first limitation of the '815 prior art system is that the bag pack must be as wide as the width of the container, i.e., the simple side gussets comprise only enough bag material required for the length of the bag when open. For relatively wide containers, the corresponding relatively wide bag pack can be ungainly to package, ship, and store in inventory.

A second limitation is that each deployed bag may have a length no greater than twice the width of the simple gusset as folded in each side; and further, each side gusset as folded may be no wider than the width of the bag, assuming that folded gussets may fully overlap.

A third limitations of any overlap of the left and right gussets is that there is no ready path for air to enter the bag, and thus overlapping folded simple gussets make any bag very difficult to open and deploy. This is an especially vexing problem for bags in a bag pack in accordance with the '815 patent because the bag being opened cannot be removed from the container and shaken to cause air to be admitted to the bag, allowing the bag to open.

What is needed in the art is an apparatus and method for forming a bag, and associated bag pack, that is a) narrower than the width of a receiving container, b) capable of being opened and deployed in a container wherein the length is more than twice the width, and c) having an inherent passage between the side gussets for air to enter in opening the bag, allowing the bag to be easily opened.

It is a principal object of the invention to facilitate the opening and deployment of longitudinally folded bags.

It is a further object of the present invention to reduce the package size and dimensions (“form factor”) of a multiple-bag pack for dispensing, loading, and removal of bags.

### SUMMARY OF THE INVENTION

Briefly described, a system in accordance with the present invention comprises at least one bag, and preferably a multiple-bag pack supportable for dispensing, loading, and removal on a structure. The bag pack includes a bag-attachment portion wherein the multiple bags are sequentially attached in a fashion similar to the pages in a paper writing tablet. Each bag is removable in sequence by separation from the pack.

It has been found that the ease of opening and deployment of a folded bag is highly dependent upon the ease with which air can be supplied to the interior of the bag. In particular, entering air is significantly inhibited from entry when opposing simple gussets overlap each other in folded mode. It will be seen from inspection that in order for opposing simple folded gussets not to overlap, the width of a gusset must be less than half the width of a bag. A result is that in such bags, the depth of the bag between the front and rear sides may be no more twice the width of a gusset, which also equals the width of the bag, i.e., a square bag. In the prior art, using simple gussets in forming a bag that is longer than its width when open requires that the folded gussets overlap within the folded bag. Even then, the length of a simple-gusset bag is limited to twice its width.

In one embodiment in accordance with the present invention, within the bag pack, each folded bag comprises at least one compound gusset folded from a corresponding simple gusset, and preferably at least one such fold in each side of a bag. As used herein, a compound gusset fold is derived from a prior art simple gusset fold comprising two outward-facing folds separated by one inward facing fold, defining thereby two gusset wings. In a compound gusset fold, each gusset wing of a simple gusset fold is further folded inward upon itself. As applied in the present invention, simple gusset folds in opposite sides of a bag do not overlap, i.e., do not cross the centerline of the bag. Thus, compound gusset folds, being formed from simple gusset folds, also do not cross the centerline of the bag.

In another embodiment in accordance with the present invention, a bag comprises a plurality of simple gussets.

It will be seen that, in accordance with the present invention, an air channel is formed between opposing gussets inherently in any bag wherein opposing gussets do not overlap. It is an important aspect of the present invention that a folded bag includes no overlapping gussets.

It will be further seen that in a compound-gusseted bag, the rearmost compound gusset may include a portion of the rear side of the bag, and the foremost compound gusset may include a portion of the front side of the bag, i.e., the folded bag width may be as little as half the deployed width of the bag, affording use of a conveniently narrower package for a bag pack (improved form factor). Further, a bag may be compound-gusseted a second or more time as may be desired, resulting in a folded bag only one-quarter or less of the deployed width of the bag.

Further in accordance with the present invention, a bag may comprise a plurality of simple or compound gusset folds in each side.

### BRIEF DESCRIPTION OF THE DRAWINGS

The present invention will now be described, by way of example, with reference to the accompanying drawings, in which:

FIG. 1 is a cross-sectional view of a system in accordance with the present invention, showing a pack of bags comprising multiple simple or compound gussets as described above, mounted on a supporting structure;

FIG. 2 is a schematic cross-sectional view taken along line 2-2 in FIG. 1, showing a simple-gusset bag folded in accordance with the prior art, wherein the length of the bag equals the width of the bag, and wherein the gussets extend only half the width of the bag and hence do not overlap;

FIG. 3 is a schematic plan view showing the bag shown in FIG. 2 in a first step in a first method for forming a compound gusset from the simple gusset;

FIG. 4 is a schematic plan view showing the bag shown in FIG. 2 in a second step in a first method for forming a compound gusset from the simple gusset;

FIG. 5 is a schematic plan view showing the bag shown in FIG. 2 in a third step in a first method for forming a compound gusset from the simple gusset;

FIG. 6 is a schematic plan view showing the bag shown in FIG. 2 in a fourth and final step in a first method for forming a compound gusset from the simple gusset;

FIG. 7 is a schematic plan view showing the bag shown in FIG. 2 in a third step in a second method for forming a compound gusset from the simple gusset;

FIG. 8 is a schematic plan view showing the bag shown in FIG. 2 in a fourth and final step in a second method for forming a compound gusset from the simple gusset;

FIG. 9 is schematic plan view showing a bag folded in accordance with the present invention, having a plurality of simple gussets (multiple inward folds) and an air channel therebetween.

Corresponding reference characters indicate corresponding parts throughout the several views. The exemplifications set out herein illustrate currently preferred embodiments of the invention, and such exemplifications are not to be construed as limiting the scope of the invention in any manner.

### DESCRIPTION OF THE PREFERRED EMBODIMENTS

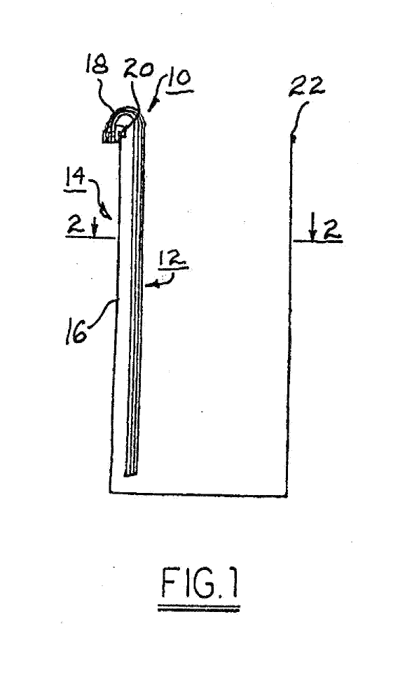

Referring to FIG. 1 for reference, and as disclosed in the incorporated '815 patent, in a presently preferred embodiment, the bag portions 12 of a pack 10 of bags are contained and hang within supportive structure 14 along side 16, and bag-attachment attachment header portion 18 is preferably, but not necessarily, folded over first lip 20, which is only a portion of the entire structure lip. Alternatively, all portions of bag pack 10 may be-disposed on the same side of supportive structure 14 (not shown). It will be seen that such folding of the attachment header portion over the first lip serves to dispose all the bag parting features of all the bags outside the structure. An exemplary supportive structure 14 comprises at least a first lip 20, and may include a second and opposed lip 22. Applying FIG. 1 to the present invention, bag portions 12 and pack 10 should be considered as being formed in accordance with the present invention and comprising bags 130,230,330 as described below.

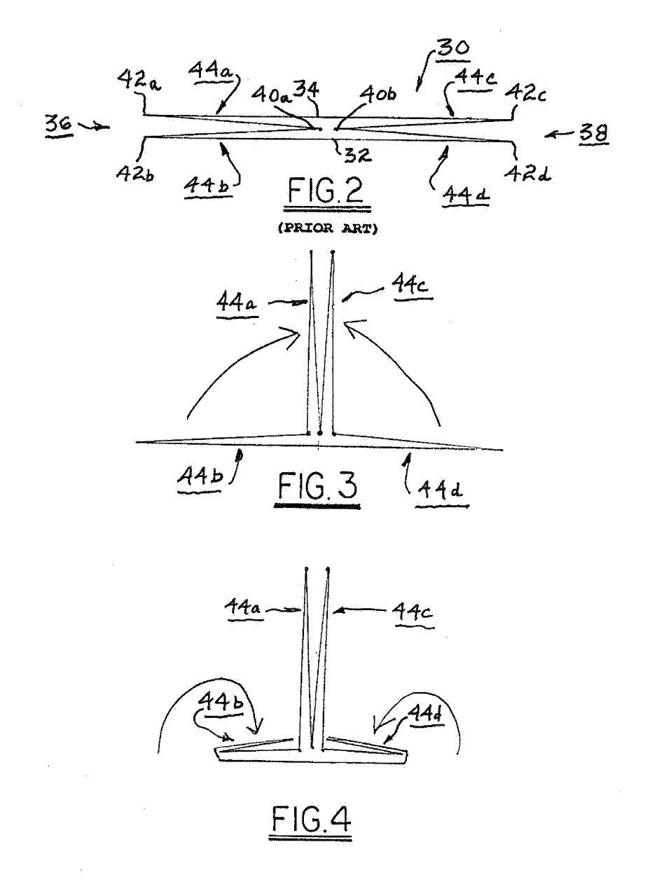

Referring now to FIG. 2, a longitudinally-folded bag 30 formed from tubular stock in accordance with the prior art comprises a rear side 32, a front side 34, a left side 36, and a right side 38. A simple gusset is formed in each of the left and right sides, comprising a single inward fold 40a and two outward folds 42a, 42b in left side 36, and a single inward fold 40b and two outward folds 42c, 42d in right side 38, resulting in first and second left wings 44a,44b and first and second right wings 44c,44d.

Referring now to FIGS. 3 through 6, a sequence of steps is shown in a first method for forming a compound gusset from a simple gusset in accordance with the present invention.

In FIG. 3, wings 44a, 44c are raised, folding side 34 in the middle.

In FIG. 4, wings 44b, 44d are folded upward and inward in the middles thereof and laid inwards on top of themselves.

In FIG. 5, folded wings 44a, 44c are lowered into the original position shown in FIG. 2.

In FIG. 6, wings 44a, 44c are folded upward and inward in the middles thereof and laid inwards on top of themselves, resulting in first novel left and right compound gussets 46a, 46b in a folded bag 130.

Referring now to FIGS. 3 and 4, and 7 and 8, a sequence of steps is shown in a second method for forming a compound gusset from a simple gusset in accordance with the present invention.

The steps shown in FIGS. 3 and 4 are common to both the first and second methods.

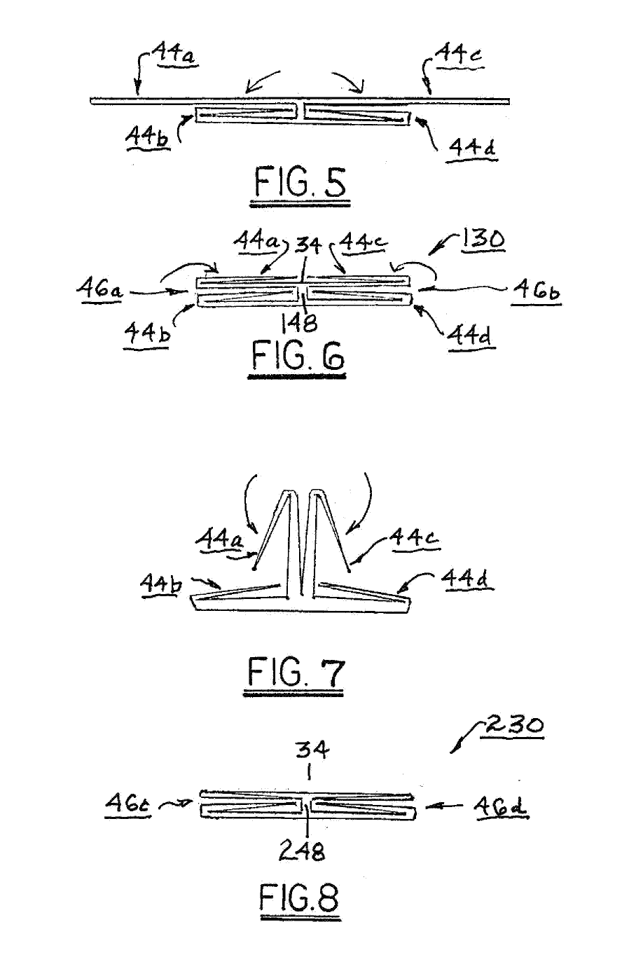

In FIG. 7, wings 44a, 44c are folded in the middles thereof and outward and downward.

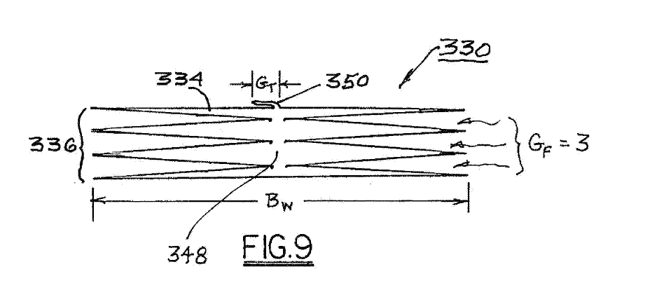

In FIG. 8, folded wings 44a, 44c are lowered onto folded wings 44b, 44d, resulting in second novel left and right compound gussets 46c, 46d in a folded bag 230.

For purposes of the present invention, a first compound gusset is considered to be a second gusset as a first simple gusset is a required antecedent.

Note that bags 130,230 are substantially only one half the width of prior art bag 30. Hence, half of front side 34 is included in first wings 44a, 44c, and a half of rear side 32 is included in second wings 44b, 44d.

Note further that because simple gussets 36,38 do not overlap across a centerline of bags 130,230 as folded in FIG. 2, novel compound gussets 46a, 46b and 46c, 46d also cannot overlap, and thus bags 130,230 comprise an inherent central air channel 148,248 between the gussets in communication with the interior of folded gusset wings 44a,44b,44c,44d, allowing air to flow easily into the folded gussets when bags 130,230 are opened by an operator pulling on front side 34.

Referring now to FIG. 9, a novel bag 330 folded in accordance with the present invention comprises a plurality of simple gussets 336. Further, an optional folded tab 350 may be formed in front side 334 to facilitate an operator's gripping a closed bag to pull the bag open.

Bag 330 comprises three simple gussets. It will be obvious to those of ordinary skill in the art that a bag in accordance with the present invention may comprise any number of simple gussets beyond one, enabling such bags to have a depth more than twice the width of the bag, as limited by one simple gusset in the prior art. It will be obvious to one of ordinary skill in the art that any and all of each simple gusset 336 can be further folded to form a compound gusset (not shown) as lust described above. Thus, a plurality of gussets in accordance with the present invention may b e selected from the group consisting of simple gussets, compound gussets, and combinations thereof.

All of novel bags 130,230,330 preferably but not necessarily are formed by folding of a continuous seamless tubular stock. (Alternatively, bags 130,230,330 may be formed by folding and seaming of continuous sheet stock to form a tubular stock in known fashion, not shown.) The circumference C_{B} of the tubular stock, and hence the bag (expressed in terms of simple gussets as shown in FIG. 9), may be calculated as follows, where G_{F} is the number of inwardly folded gussets; B_{W} is the width of the bag, and hence the width of a multiple bag pack 10 as shown in FIG. 1; and G_{T} is the width of tab 350:

C_{B}=2(B_{W}+G_{F}+G_{T}) Equation 1

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A method for folding stock material to form a bag having a front side, a rear side, and left and right sides connecting said front and rear sides, comprising the steps of:
a) providing a first simple gusset in at least one of said left and right sides; and
b) forming a second gusset in at least one of said left and right sides,
wherein said second gusset is selected from the group consisting of a second simple gusset and a compound gusset formed from said first simple gusset.

2. (canceled)

3. A method in accordance with Claim 1 wherein said second gusset is formed in both of said left side and said right side.

4. A method in accordance with claim 2 wherein neither of said left side and right side gussets extends across a centerline of said bag.

5. A method in accordance with claim 4 wherein an air channel is provided in said folded bag between said left side and right side gussets.

6. A method in accordance with claim 1, wherein said first simple gusset comprises a single inward fold and two outward folds in at least one of said left side and said right side to produce first and second wings wherein said first wing includes one of said front side and said rear side, and wherein said second wing includes the other of said front side and said rear side, and
wherein said forming step for said compound gusset comprises the further steps of:
a) first folding a portion of said first wing onto the remaining portion of said first wing; and
b) second folding a portion of said second wing onto the remaining portion of said second wing.

7. A method in accordance with claim 6 wherein said remaining portion of said first wing comprises half of said first wing.

8. A method in accordance with claim 6 wherein said remaining portion of said second wing comprises half of said second wing.

9. A method in accordance with claim 1 comprising the further step of forming one or more additional gussets in at least one of said left and right sides,
wherein said one or more additional gussets are selected from the group consisting of simple gusset, compound gusset, and combinations thereof.

10. A method in accordance with claim 1 comprising the further step of forming a tab in said front side.

11. A method in accordance with claim 1 wherein said stock material is selected from the group consisting of seamless tubular stock and seamed sheet stock.

12. A bag having a front side, a rear side, and left and right sides connecting said front and rear sides, and having at least one simple gusset formed in each of said left and right sides, said bag being folded further to form at least one compound gusset formed from one of said left side and right side simple gussets, said left and right side simple and compound gussets and said front and rear sides being sealed together in only a bottom bag seam, the opposite ends of said left and right side simple and compound gussets being free to unfold when said bag is opened for use.

13. A bag in accordance with claim 12 wherein none of said left side and right side gussets extends across a centerline of said bag.

14. A bag in accordance with claim 13 comprising an air channel in said folded bag between said left side and right side gussets.

15. (canceled)

16. A bag in accordance with claim 12 wherein said bag is one of a plurality of such bags stacked in a bag pack.

17. A bag in accordance with claim 16 wherein the width of a bag in said bag pack may be as little as half the width of said bag when opened for use.

18. A bag pack comprising a plurality of stacked folded bags, wherein at least one of said folded bags comprises a plurality of inwardly-folded gusset folds formed in each of the left and right sides thereof, said plurality of inwardly-folded gusset folds and said front and rear sides being sealed together in only a bottom bag seam, said left and right sides and the opposite ends of said inwardly-folded gusset folds being free to unfold when said bag is opened for use.

19. A bag having a front side, a rear side, and left and right sides connecting said front and rear sides, and having a plurality of inwardly-folded gusset folds formed in each of said left and right sides, said left and right side gusset folds and said front and rear sides being sealed together in only a bottom bag seam, the left and right sides and opposite ends of said left and right side gusset folds being free to unfold when said bag is opened for use.
